(19) United States
(12) Patent Application Publication
(10) Pub. No.: US 2002/0091490 A1
(43) Pub. Date: Jul. 11, 2002

(54) System and method for representing and manipulating biological data using a biological object model

(76) Inventors: Frank D. Russo, Sunnyvale, CA (US); Greg L. Pelts, Sunnyvale, CA (US); Robert Gupta, San Jose, CA (US); Elizabeth Corey, Belmont, CA (US)

Correspondence Address: SQUIRE, SANDERS & DEMPSEY L.L.P, 600 HANSEN WAY, PALO ALTO, CA, 94304-1043, US

(21) Appl. No.: 09/948,383

(22) Filed: Sep. 6, 2001

Related U.S. Application Data
(60) Provisional application No. 60/230,665, filed on Sep. 7, 2000.

(51) Int. Cl. G06F 19/00

(52) U.S. Cl. 702/19

(57) ABSTRACT

A system for representing and manipulating biological data using a biological object model. The system comprises a biological database, a database engine, a biological object model, and a data-mapping engine. The database engine searches and retrieves biological data from the database. The data-mapping engine substantiates biological objects from retrieved data using definitions from the biological object model.

### PRIORITY REFERENCE TO PRIOR APPLICATIONS

This application claims benefit of and incorporates by reference patent application serial No. 60/230,665, entitled “Biological Object Model,” filed on Sep. 7, 2000, by inventors Greg L. Pelts, Frank D. Russo, Robert Gupta, Elizabeth Corey, Pragna Parmar, Padmaja Kulkarni, and Ljubomir Buturovic.

### TECHNICAL FIELD

This invention relates generally to biological databases and software applications, and more particularly, but not exclusively, provides a system and method for representing and manipulating biological data using a biological object model.

### BACKGROUND

Conventionally, biological data is stored and represented in a manner that is consistent with the way the data was generated. Representing the biological data in a way that is consistent with the way the data was generated is a good technique for publishing the generated data and enabling a user to examine and validate the generated data.

However, representing data in a manner that reflects the way the data was generated leads to problems when trying to integrate data generated using two or more different techniques. Accordingly, it may be extremely hard to share and exchange data between two or more databases due to the different data formats. This may limit collaboration between researchers, slow the progress of research, and possibly lead to needless duplication of data generation and conversion efforts.

Therefore, a new system and method for representing biological data may be needed.

### SUMMARY

The present invention provides a system for representing and manipulating biological data using a biological object model. The system provides a unified technique of representing biological data as biological objects in a manner that reflects the fundamental relationships between biological concepts and not in a constrained manner that reflects the way the biological data was generated. Furthermore, this object-oriented approach allows not only static representation of the data, but definition of the behavior of each biological object as well.

The system comprises a database engine, a biological object model, a data mapping engine and a database. The database may be a relational database or other type of database that stores biological data. The biological object model includes biological object descriptions. Each biological object description may include attributes, behavior, and relationship to other objects. Further, biological objects may inherit attributes and behaviors from other biological objects. The database engine enables a user to retrieve biological data from the database stored in any format and, in conjunction with the data mapping engine, represent that data as objects according to the biological object model.

The present invention further provides a method for accessing biological data using a biological object model. The method comprises: receiving a request to access biological data from a biological database; searching the database for the data; retrieving the data; and placing the data into objects according to a biological object model.

The system and method may advantageously enable users to represent biological data as biological objects.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a computer system in accordance with a first embodiment of the present invention;

FIG. 2 is a block diagram illustrating an embodiment of persistent memory from the computer system of FIG. 1;

FIG. 3. is a block diagram illustrating layers of an embodiment of a biological object model from the persistent memory of FIG. 2;

FIG. 4 is a diagram illustrating four example objects from an embodiment of a science layer from the biological object model of FIG. 3;

FIG. 5 is a block diagram illustrating inheritance among objects in a biological object model taxonomy;

FIG. 6 is a block diagram illustrating the science layer from the biological object model of FIG. 3;

FIG. 7 is a block diagram of an embodiment of an analysis layer from the biological object model of FIG. 3;

FIG. 8 is a block diagram illustrating an embodiment of a services layer from the biological object model of FIG. 3; and

FIG. 9 is a flowchart illustrating a method for representing data from a database using the biological object model of FIG. 3.

### DETAILED DESCRIPTION OF THE ILLUSTRATED EMBODIMENTS

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

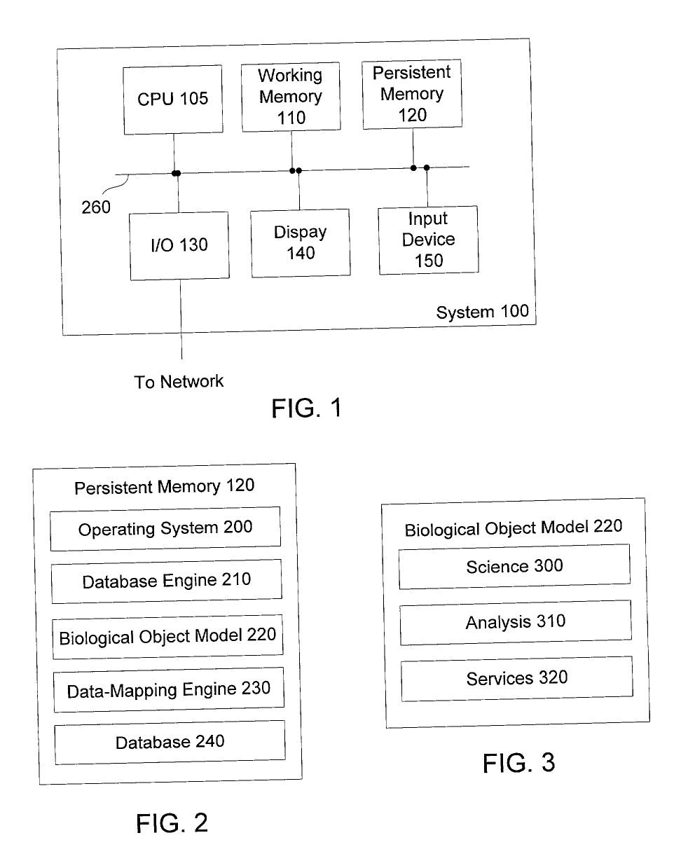

FIG. 1 is a block diagram illustrating a system 100 in accordance with the present invention. The system includes a central processing unit (CPU) 105; working memory 110; persistent memory 120; input/output (I/O) interface 130; display 140 and input device 150, all communicatively coupled to each other via system bus 160. CPU 105 may include an Intel Pentium® microprocessor, a Motorola Power PC® microprocessor, or any other processor capable to execute software stored in persistent memory 120. Working memory 110 may include random access memory (RAM) or any other type of read/write memory devices or combination of memory devices. Persistent memory 120 may include a hard drive, read only memory (ROM) or any other type of memory device or combination of memory devices that can retain data after example computer 100 is shut off. I/O interface 130 is optionally communicatively coupled, via wired or wireless techniques, to a network, such as the Internet. In an alternative embodiment of the invention, I/O 230 may be directly communicatively coupled to a server or computer, thereby eliminating the need for a network. Display 140 may include a cathode ray tube display or other display device. Input device 150 may include a keyboard, mouse, or other device for inputting data, or a combination of devices for inputting data.

One skilled in the art will recognize that the system 100 may also include additional devices, such as network connections, additional memory, additional processors, LANs, input/output lines for transferring information across a hardware channel, the Internet or an intranet, etc. One skilled in the art will also recognize that the programs and data may be received by and stored in the system in alternative ways.

FIG. 2 is a block diagram illustrating persistent memory 120 (FIG. 1). Memory 120 includes an operating system (“O/S”) 200, a database engine 210, a biological object model 220, a data mapping engine 230, and a database 240. O/S 200 may include Microsoft Window NT®, Linux, or any other O/S. Database engine 210 enables a user to search database 240 as well as store and retrieve data from database 240.

The biological object model 220 includes biological object descriptions for presenting data from database 240. Each object may include attributes, behaviors (e.g. methods), and relationships to other objects. Further, an object may inherit properties from another object. The biological object model 220 and its components will be discussed in further detail in conjunction with FIGS. 3-6 below.

The data-mapping engine 230 converts retrieved data into objects per the biological object model 220 by knowing conventional biological data formats and accessing model 220. For example, data in database 240 may be stored in a GenBank flatfile format. When database engine 210 retrieves data from database 240 in the GenBank format, the data-mapping engine 230 can convert the data from the GenBank format to a biological object per the biological object model 220. Database 240 may include a relational database, object-oriented database, or any other type of database. Database 240 may store biological data in any type of format or in a plurality of formats, such as GenBank, SWISS-PROT, and PIR.

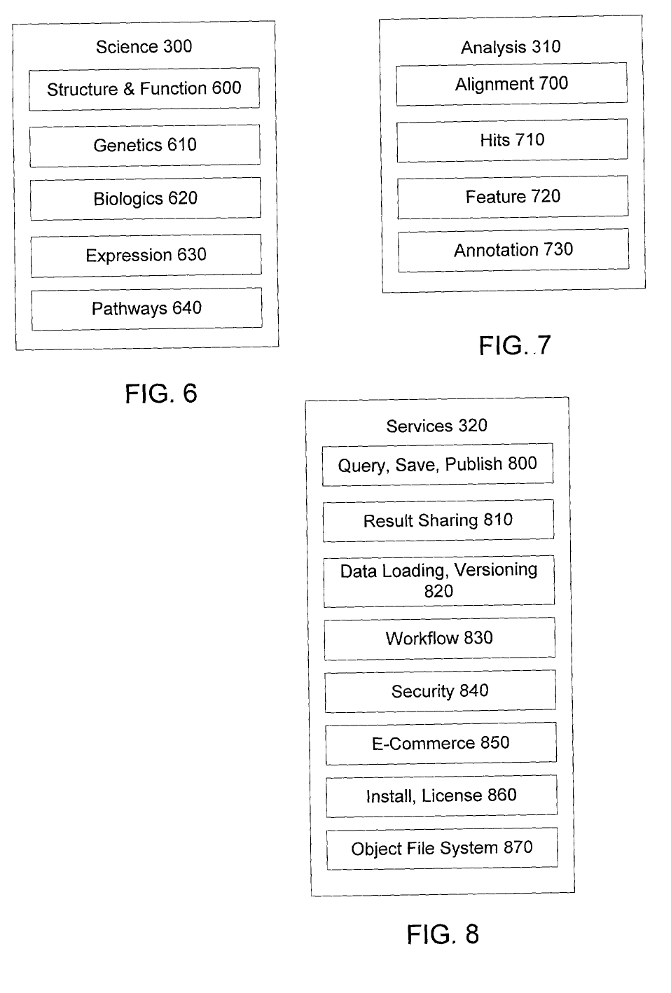

FIG. 3. is a block diagram illustrating layers of the biological object model 220. The biological object model 220 includes a science layer 300, an analysis layer 310, and a services layer 320. The science layer 300 includes scientific concepts and physical structures modeled by the Object model 220. The science layer 300 will be discussed in further detail in conjunction with FIG. 6. The analysis layer 310 includes genomic research analytical tools and will be discussed in further detail in conjunction with FIG. 7. The services layer 320 provides functionality to the object model 220. The services layer 320 will be discussed in further detail in conjunction with FIG. 8.

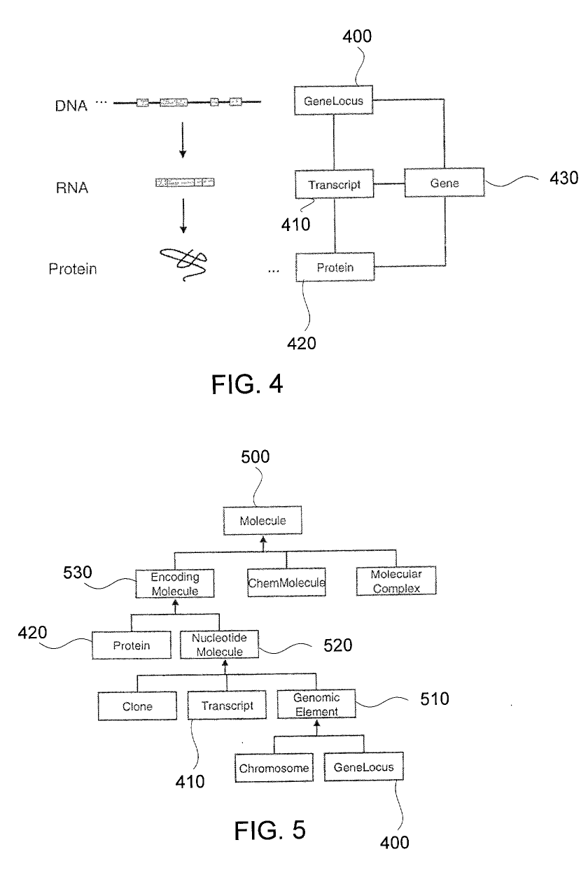

FIG. 4 is a diagram illustrating four example objects from science 300. An organism's genome can be generally defined as all the genetic material in the chromosomes of the particular organism. However, the organism's DNA, RNA, RNA-produced proteins, and their interrelationships may be as important as the genome itself. To model a genome, the biological object model 220 defines a gene object 430, which is a unit of function or information. Closely related to the gene object 430 are the GeneLocus object 400, the transcript object 410, and the protein object 420, which correspond to DNA, RNA, and protein, respectively. The objects 400-430 not only include attributes, but also include methods (e.g., DNA produces RNA, which produces protein) and their interrelationships.

FIG. 5 is a block diagram illustrating inheritance among objects in a biological object model 220 taxonomy. The GeneLocus object 400, the transcript object 410, and the protein object 420 are also molecules and accordingly all inherit attributes from the molecule object 500. Further, each object may inherit attributes from objects in a higher class. For example, GeneLocus 400 inherits attributes from Genomic Element 510, which in turn inherits attributes from Nucleotide Molecule 520, which in turn inherits attributes from Encoding Molecule 530, which in turn inherits attributes from Molecule 500.

FIG. 6 is a block diagram illustrating the science layer 300. The science layer 300 comprises structure and function 600, genetics 610, biologics 620, expression 630, and pathways 640.

Structure and function 600 includes objects that separate the physical and informational concepts of molecular biology, i.e., the structure and function 600 module treats an informational string of bases and amino acids in a sequence separate from its physical aspects as represented by a clone or transcript molecule. For example, structure and function 600 includes map objects that have purely informational attributes such as ordered strings of adenine, guanine, cytosine, and thymine that provide all information necessary to describe a TranscriptSequence object, which is a subclass of the Map object. In contrast to the TranscriptSequence object, a Transcript object, which is a subclass of the Molecule object 500, describes the mRNA transcript that one theoretically could, technology permitting, retrieve from a cell and inspect as a standalone molecule.

Molecule object 500 may include subclasses EncodingMolecules (not shown), ChemMolecules (not shown), MolecularComplex (not shown), and Composite Molecules (not shown) objects to further describe the physical aspects of molecular biology. EncodingMoleclues are objects whose core informational and functional natures are determined by the primary sequence of their residues. EncodingMoleclues objects may be further defined by subclasses Proteins, NucleotideMolecules, Transcripts, GenomicElements, Chromosomes, GeneLoci, Clones, Vectors, PCRProducts, OligoNucleotides, and StructuraIRNAs.

ChemMolecules objects are generally objects for describing small molecules that do not have a linear set of residues that can be used to fully describe them. MolecularComplex objects are objects that describe molecules composed of several Molecules that perform a function as group, such as hemoglobin and ribosome.

Composite Molecules objects are conceptually, rather than physically, associated Molecules. Composite Molecules are also not a new class per se, but a self-referential relationship of the Molecule class. For example, it might be useful to refer to hexokinase as a Molecule object, even though there are a number of different hexokinase Molecules (rat hexokinase 1, rat hexokinase 2, human hexokinase 1, etc.). These can be referred to collectively as the composite hexokinase Molecule object, that is composed of all of the various EncodingMolecules referred to above. Another example is to create a composite, or aggregate Molecule to represent all the transcripts from a given gene. This is useful in microarray analysis, where often the specificity of the expression by a single transcript cannot be determined.

Informational objects from structure and function 600 include map objects that can be described using a coordinate system. There are four subclasses of map objects including Chromosome Maps (not shown), Sequences (not shown), Motifs (not shown) and Structures (not shown). Chromosome map objects provide a positional reference on the chromosome for genes, disease loci, or other position-based assignments on the chromosome. There are four types of Chromosome Map objects including PhysicalMaps, which is based on raw sequence data listed in base pairs, GeneticMaps, which are based on the segregation rate of two loci on a chromosome and may be listed in centiMorgans (cM), RHMaps, or radiation hybrid maps, which use centirads (cR) as a unit of distance, and CytogeneticMaps, which use the characteristic light/dark staining pattern of the chromosomes as chromosomal coordinate markers.

Sequence objects include a super class object bioseq, and subclasses ProteinSeq and NucleotideSeq. Further, NucleotideSeq can be further subdivided into TranscriptSeq and GenomicSeq. Sequence objects encompass all of the primary sequence data that molecular biologists classically think of when they refer to gene, transcript, or protein sequences, and is analogous to the use of the term in public databases such as GenBank. The key difference in the object model 220 is that sequence objects are purely informational entities that are realized in the physical realm by an associated EncodingMolecule. For the BioSeq object, the sequence of the object is its definitive attribute.

Motif objects are generally used to describe a conserved domain of the EncodingMolecule. Motif is an abstract class that is generally realized in its subclasses: RegularExpressionMotif, ProfileMotif, and HMMMotif. A RegularExpressionMotif is composed of simple phrases or words within a Map that are used for exact matches, while a ProfileMotif conveys a more complex description of EncodingMolecules. Finally, an HMMMotif (Hidden Markov Model Motif) is a consensus statistical model of the critical features within EncodingMolecules.

Structure objects include StructureSecondary and StructureTertiary objects, which inherit from the Map class. Quartenary structure is not a class in the model, but the concepts of these higher order structures are contained within the MolecularComplex class described above. StructureSecondary defines the less complex structural elements of EncodingMolecules using a one-dimesional coordinate system. In the case of Proteins, alpha-helices, beta-sheets, and coiled-coils would be described using this class. Note that each of these examples of secondary structure describes a structure based on sequence and require only a one-dimensional coordinate system. This contrasts with StructureTertiary, which describes Molecules in three-dimensional space. StructureTertiary is a class used to describe Molecules whose complete structure has been experimentally determined using techniques such as X-ray crystallography.

Genetics 610 includes objects for modeling heritable materials and variations in those materials. Genetics 610 includes a Genotype object class that describes the heritable material itself, while a Polymorphism object class describes the variations in the heritable material. Each instance of a polymorphism object describes a point or region of observed variation in the genome. Genetics 610 may also include an Allele class object to describe a single variant among the several observed within a polymorphic region of the genome. That region can be a single nucleotide, a gene, or other defined stretch of genomic material. There may be any number of Alleles associated with a Polymorphism. Further, genetics 610 may include a Haplotype class object to define a set of closely linked alleles on the same chromosome. A MultiploidGenotypes class object can be composed of one or more Haplotypes, representing sets of alleles on opposite chromosomes.

Biologics 620 provides objects for descriptions of individuals, samples, and biologic events that are necessary for thorough scientific documentation and evaluation. For example, when a cDNA library is prepared from a laboratory mouse, instances of biologics 620 objects contain the strain, age, and weight of the mouse, as well as the specific type of tissue used, and the lab procedures used to extract mRNA and prepare cDNA from that sample.

Objects from biologics 620 include Individual objects and Sample objects that are derived from Individuals. Subclasses of Individuals include Animal, Plant, and Culture Objects. Subclasses of Sample include TissueSpecimen and Library objects. Example attributes of Individual include date of birth and a date of death. Example attributes of Sample include age, weight, and anatomical location.

Biologics 620 also provides objects for biologic events of individuals in subclasses EventType and EventOccurrence. For example, an EventType might include cancer, while an EventOccurrence may be the onset of the cancer for a particular individual. Creating separate EventType objects and EventOccurrence objects enables a user to represent general data about an event, such as cancer, with the EventType object, and specific information about the temporal and case specific aspects of the event with the EventOccurrence object.

Many biologic events may also be presented as procedure objects in the object model 220. This class has four direct subclasses called SurgicalProcedure, Test, Treatment, and PlantHarvest. SurgicalProcdedure is a fairly self-explanatory class, while Test is most commonly used to describe diagnostic tests. Treatment is an important class that adds the attribute of dosage. The treatment object may also have attributes of laboratory time and concentration courses with particular drugs or chemicals, pharmaceuticals delivered to patients, and an individual's history of tobacco and alcohol use. Note that unlike other Procedures, which use the generic EventOccurrence, Treatment uses the specialized TreatmentOccurrence class.

Expressions 630 enables a user to model gene expressions using three primary classes of objects: transcript and protein objects, which identify molecules that are sources of expression data; BioMaterial objects, which defines where the expression is being assayed; and ExpressionValue objects, which present a numeric representation of the expression level of a molecule.

In general, expression 630 objects can be classified as technology-dependent objects and technology-independent objects. Technology-independent objects include ExpressionValueSets, which is a set of ExpressionValue objects. An ExpressionValueSet is a two-dimensional array with axes defined by a MoleculeSet and a BioMaterialSet. In practice these are column- and row-headers for the array where MoleculeSets and BioMaterialSets are lists of Molecules and BioMaterials respectively. Consequently, this storage mechanism provides a single place to store large expression experiments involving thousands of Transcripts assayed over any number of BioMaterials. Individual ExpressionValues can be returned from the array using a given Molecule (e.g. hexokianse-1 mRNA) and BioMaterial (e.g. stimulated T cells). The Molecule and BioMaterial thus form the coordinates of the ExpressionValueSet.

Technology-dependent objects include DesignElement objects, which represent transcripts spotted or built on a fixed substrate in a defined coordinate system that can be tracked across experiments. Generally, an instance of a DesignElement object contains a recognizor molecule, not the recognized molecule. In Transcript microarray analysis, the recognizor and recognizee are generally they same, but this would not be true in an array of antibodies that each recognize a defined protein. In this case, the recognizor is the antibody Protein, while the recognizee is the Molecule that that antibody binds to.

Other technology-dependent objects include SchemeBlock, SchemeMolecule, SchemeAtom objects for describing structure of a microarray, such as those from Affymetrix, that use multiple recognizor molecules to recognize a single molecule. An ExpressionAssay object represents the actual assay used to measure expression levels of a set of Molecules. For microarray technologies, this object is realized in a Hybridization object, which is a subclass of ExpressionAssay. For two-dimensional gel-based technologies, a Protein2DGel object is used.

Pathways 640 provides pathway objects for enabling representation of a collection of molecules interacting through a series of steps represented by PathwayStep objects. The Molecules and PathwaySteps are themselves defined independently, then associated with a Pathway via MoleculeOccurrence and PathwayStepOccurrence objects. This approach allows the treatment of a pathway as a hypothetical construct, capturing a scientist's view of how multiple steps fit together, while treating individual molecules or steps as independently determined facts, separate from any hypothesis of how they interconnect. There is no restriction on the number of molecules or steps that may be combined in a single pathway, or on how they interconnect.

In other words, the term “Pathway” does not imply that steps must occur sequentially in a linear fashion. Neither is there any restriction on the nature of steps that may be connected, i.e., a single pathway may contain any combination of biochemical, regulatory, gene expression, or other type of steps. Any time the same molecule participates in multiple steps, those steps may be connected to each other in a pathway.

FIG. 7 is a block diagram of analysis layer 310, which includes alignment 700, hits 710, feature 720, and annotation 730. The analysis layer 310 provides objects to describe and compare instances of other objects within the model 220. The analysis layer 310 enables a user to relate and annotate the data in ways that further the understanding of core data sets.

Annotation 730 includes annotation objects codifying textual, numeric, and object-based descriptions of objects enabling a user to add notes or descriptions to any other object. For example, a user might add a comment to a new Transcript such as “this transcript appears to be very important to thrombocytopenia.”

A subclass of the annotation class is a feature object class 720. A feature object can be used for annotating an instance of a map object, i.e., the feature object not only annotates an object instance, but also a specific region of the object instance.

Alignment 700 includes alignment objects for alignment of two or more instances of map objects. These alignments can use the same or different coordinate systems, and can be composed of either relatively simple Block alignment objects or involve multiple Block alignments using a ComplexAlignment object. In a simple alignment between two sequences, such as two GenBank NucleotideSeqs, a single Block alignment is associated with each of these two maps via an AlignmentDescriptor object. The AlignmentDescriptor stores the start and stop positions of aligned regions (RegionAlignmentDescriptor), or the positions and lengths of gaps (GapAlignmentDescriptor), for each sequence or Map participating in an Alignment. Note that Alignments objects describe both the physical alignment (which region or bases to align) and qualifications for that alignment (Pctldentity, Score, and Evalue).

Hits 710 provides objects for describing qualified comparisons (Evalues, Scores, and Pctldentities) between two Map objects. MapHit objects are similar to Alignment objects, except that MapHits do not build the actual alignment or give comparative positions between two Maps. In addition, MapHits are strictly pairwise comparisons, while Alignments can be between two or more Maps.

FIG. 8 is a block diagram illustrating services layer 320. Services 320 provides tools for a user and may include query, save publish 800, result sharing 810, data loading, versioning 820, workflow 830, security 840, E-commerce 850, Install, License 860, and Object File System 870.

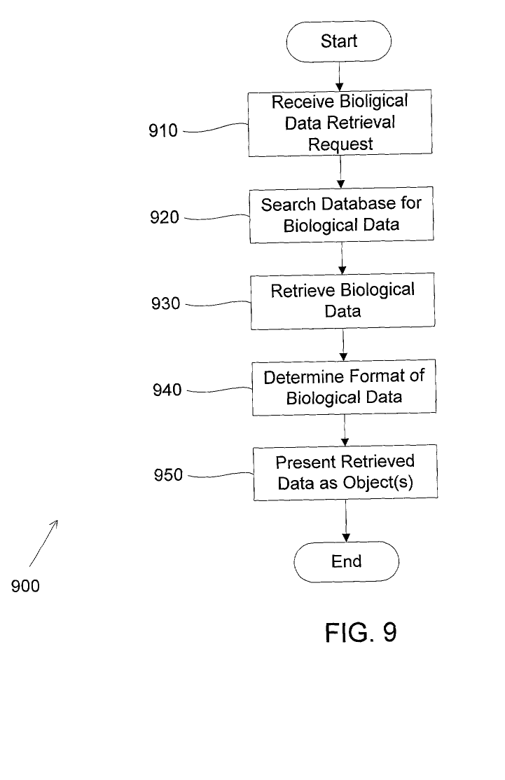

FIG. 9 is a flowchart illustrating a method 900 for representing data from database 240 using biological object model 220. In an embodiment of the invention, database engine 210 and data-mapping engine 230 may simultaneously run several instances of method 900. For example, multiple users may want to retrieve data from database 240 via a network connection.

First, a database engine, such as database engine 210, receives (910) a request for biological data. Next, a database engine, such as database engine 210, searches (920) a database, such as database 240, for the requested biological data. After the requested biological data is located in the database, the database engine retrieves (930) the biological data. Next, a data-mapping engine, such as data-mapping engine 230, determines (940) the format of the retrieved biological data. The biological data may already be in a biological object model format or may be other formats, such as GenBank or SWISS-PROT.

After determining (940) the format of the retrieved biological data, the database engine 210 presents (950) the retrieved data as biological objects per biological object model 220. Presenting (950) may include displaying, transmitting, printing or any other technique of outputting biological data. If the retrieved biological data is already in a biological object format, then the data can be presented as is. If not, then the data-mapping engine 230 first “translates” the retrieved biological data to biological object format. The data-mapping engine 230, based on the determination of the format of the retrieved data, translates the retrieved data to objects using definitions of objects from the biological object model 220. The database engine 210 then presents (950) the translated data. Method 900 then ends.

The foregoing description of the preferred embodiments of the present invention is by way of example only, and other variations and modifications of the above-described embodiments and methods are possible in light of the foregoing teaching. Components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method, comprising:
receiving a biological data retrieval request;
retrieving the biological data corresponding to the request;
substantiating the retrieved biological data as biological objects per a biological object model based on biological concepts, the biological objects each including at least one attribute, at least one behavior and at least one relationship to at least one other biological object.

2. The method of claim 1, wherein the biological object model enables object classes to inherit attributes from other object classes.

3. The method of claim 2, wherein the retrieving retrieves the biological data from a relational database.

4. The method of claim 2, wherein the biological object model includes definitions for structure & function, genetics, biologic, and expression objects.

5. The method of claim 4, wherein the biological object model includes definitions for structure & function objects, with separate definitions for informational and physical objects to respectively represent informational and physical aspects of molecules.

6. The method of claim 4, wherein the expression object definitions includes an ExpressionValueSet object definition, wherein the ExpressionValueSet object definition includes a 2-dimensional array with axes defined by a MoleculeSet and a BioMaterialSet.

7. The method of claim 2, wherein the biological object model includes pathway object definitions.

8. The method of claim 7, wherein the pathway object definitions enable substantiation of a collection of molecule objects interacting through a series of steps represented by PathwayStep objects.

9. The method of claim 2, wherein the biological object model includes analysis objects.

10. The method of claim 9, wherein the analysis objects include alignment, hits, feature, and annotation object definitions.

11. A machine-readable medium having stored thereon machine-readable code to permit a machine to effect a marketing method, the method comprising:
receiving a biological data retrieval request;
retrieving the biological data corresponding to the request;
substantiating the retrieved biological data as biological objects per a biological object model based on biological concepts, the biological objects each including at least one attribute, at least one behavior and at least one relationship to at least one other biological object.

12. The machine-readable medium of claim 11, wherein the biological object model enables object classes to inherit attributes from other object classes.

13. The machine-readable medium of claim 12, wherein the retrieving retrieves the biological data from a relational database.

14. The machine-readable medium of claim 12, wherein the biological object model includes definitions for structure & function, genetics, biologic, and expression objects.

15. The machine-readable medium of claim 14, wherein the biological object model includes definitions for structure & function objects, with separate definitions for informational and physical objects to respectively represent informational and physical aspects of molecules.

16. The machine-readable medium of claim 14, wherein the expression object definitions includes an ExpressionValueSet object definition, wherein the ExpressionValueSet object definition includes a 2-dimensional array with axes defined by a MoleculeSet and a BioMaterialSet.

17. The machine-readable medium of claim 12, wherein the biological object model includes pathway object definitions.

18. The machine-readable medium of claim 17, wherein the pathway object definitions enable substantiation of a collection of molecule objects interacting through a series of steps represented by PathwayStep objects.

19. The machine-readable medium of claim 12, wherein the biological object model includes analysis objects.

20. The machine-readable medium of claim 19, wherein the analysis objects include alignment, hits, feature, and annotation object definitions.

21. A biological database system, comprising:
means for receiving a biological data retrieval request;
means for retrieving the biological data corresponding to the request;
means for substantiating the retrieved biological data as biological objects per a biological object model based on biological concepts, the biological objects each including at least one attribute, at least one behavior and at least one relationship to at least one other biological object.

22. A biological database system, comprising:
a database capable to store biological data;
a database engine, communicatively coupled to the database, capable to search for and retrieve data from the database;
a biological object model, communicatively coupled to the database engine, capable to store definitions for biological objects, the definitions capable to represent biological data as objects based on biological concepts, the biological objects each including at least one attribute, at least one behavior and at least one relationship to at least one other biological object; and
data-mapping engine, communicatively coupled to the biological object model, capable to substantiating biological objects from retrieved data per the biological object model.

23. The system of claim 22, wherein the biological object model enables object classes to inherit attributes from other object classes.

24. The system of claim 23, wherein the database includes a relational database.

25. The system of claim 23, wherein the biological object model includes definitions for structure & function, genetics, biologic, and expression objects.

26. The system of claim 25, wherein the biological object model includes definitions for structure & function objects, with separate definitions for informational and physical objects to respectively represent informational and physical aspects of molecules.

27. The system of claim 25, wherein the expression object definitions includes an ExpressionValueSet object definition, wherein the ExpressionValueSet object definition includes a 2-dimensional array with axes defined by a MoleculeSet and a BioMaterialSet.

28. The system of claim 23, wherein the biological object model includes pathway object definitions.

29. The system of claim 28, wherein the pathway object definitions enable substantiation of a collection of molecule objects interacting through a series of steps represented by PathwayStep objects.

30. The system of claim 23, wherein the biological object model includes analysis objects.

31. The system of claim 30, wherein the analysis objects include alignment, hits, feature, and annotation object definitions.
